(19) United States
(12) Patent Application Publication
(10) Pub. No.: US 2006/0143233 A1
(43) Pub. Date: Jun. 29, 2006

(54) Embedding location information in content objects

(75) Inventor: Philip J. Pietraski, Huntington Station, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/285,895

(22) Filed: Nov. 23, 2005

Related U.S. Application Data
(60) Provisional application No. 60/630,871, filed on Nov. 24, 2004.

(51) Int. Cl. G06F 17/00

(52) U.S. Cl. 707/104.1

(57) ABSTRACT

A method for embedding location information in a content object created on a content creation device begins by obtaining location information relating to the current location of the content creation device. The content object is created and the location information is embedded into the content object. A method for displaying location information in connection with a content object begins by selecting a content object to view. The embedded location information is extracted from the selected content object. The location information is interpreted to determine user-friendly location information. The user-friendly location information is displayed with the selected content object.

### CROSS REFERENCE TO RELATED APPLICATION

This application claims the benefit of U.S. Provisional Application No. 60/630,871, filed Nov. 24, 2004, which is incorporated by reference as if fully set forth herein.

### FIELD OF INVENTION

The present invention relates generally to content management systems, and more particularly, to a method and system for embedding location information in content objects created using a content creation device.

### BACKGROUND

The widespread popularity of camera phones has demonstrated that people are interested in convenient picture taking while on the go. Automatically storing date and time information onto conventional (film) photographs has also shown to be popular with many people, to help aid them in remembering the circumstances surrounding their photographs during later viewing. Embedding the date and time information into digital photographs has been less popular, presumably because the date and time information is already captured by the digital camera's file system. No information regarding the location of the camera is presently captured either implicitly or explicitly, making recall of the location of the photograph during later viewing or when sharing photographs with others more difficult.

### SUMMARY

The present invention solves the problem of the prior art by embedding location information into the recording, e.g., a photograph, by using available location information obtainable from the serving cell location, location services (LCS), GPS, voice input, or other means. Look-up tables stored locally or downloaded into the recording device can be used to translate the raw location information into more user-friendly categories such as country, state, city, landmark, etc. according to the available resolution of the location information.

A method for embedding location information in a content object created on a content creation device begins by obtaining location information relating to the current location of the content creation device. The content object is created and the location information is embedded into the content object.

A method for displaying and exporting location information in connection with a content object begins by selecting a content object to view. The embedded location information is extracted from the selected content object. If the location information is embedded into the content object in an overt manner, such as text in a photograph, then the location information need not be extracted from the content object since it will be readily apparent upon observation of the content object. The location information is interpreted to determine user-friendly location information. The user-friendly location information is displayed with the selected content object as desired.

A system for embedding location information in a content object includes a content creation device, a first location determining device, and a location embedding device. The content creation device is configured to create a content object. The first location determining device is configured to determine geographic location information of the content creation device. The location embedding device is configured to embed the location information into the content object. Where the content creation device is located on a wireless device, the system optionally includes a wireless network, through which the wireless device communicates, the wireless network having a second location determining device, configured to assist or be used as an alternative to, the first location determining device in determining geographic location information of the wireless device.

A system for displaying user-friendly location information with a content object includes a location extracting device, a first location interpreting device, and a display. The location extracting device is configured to extract location information from a content object. If the location information is embedded into the content object in an overt manner, such as text in a photograph, then the location extracting device is not needed since the location information will be readily apparent upon observation of the content object. The first location interpreting device is configured to interpret the extracted location information into a user-friendly format. The display is configured to display the user-friendly location information along with the content object. Where the system operates on a wireless device, the system optionally includes a wireless network, through which the wireless device communicates, the wireless network including a second location interpreting device, configured to assist or be used as an alternative to, the first location interpreting device in interpreting the extracted location information into a user-friendly format.

A content creation device for embedding location information in a content object includes a multimedia creation device, a location determining device, and a location embedding device. The multimedia creation device is configured to create a content object. The location determining device is configured to determine a location of the content creation device. The location embedding device is configured to embed the location of the content creation device into the content object.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a flowchart of a method for embedding location information in content object created by a content creation device;

FIG. 2 is a flowchart of a method for displaying location information in connection with a content object;

FIG. 3 is a block diagram of a system for embedding location information in a content object and extracting location information from a content object; and

FIG. 4 is a diagram of a system using the method shown in FIG. 1.

### DETAILED DESCRIPTION OF THE PREFERRED EMBODIMENTS

Hereafter, the term “wireless device” includes, but is not limited to, a wireless transmit/receive unit, a user equipment, a mobile station, a fixed or mobile subscriber unit, a pager, or any other type of device capable of operating in a wireless environment. When referred to hereafter, the term “base station” includes, but is not limited to, a Node B, a site controller, an access point, or any other type of interfacing device in a wireless environment.

While the description of the present invention uses a camera phone as an example, the invention applies generally to any content creation device capable obtaining some information regarding the location of the content object that is created. Other devices can be used within the scope of the present invention. For example, a content creation device may be any type of wireless device. In one embodiment, the content creation device is a wireless device equipped with a GPS receiver to determine the location of the device or equipped with a sound recording device such that a user of the device can verbally describe the recording and associate the verbal description with the recording.

Although the invention describes embedding location information into a recording, it is recognized that other auxiliary information may also be embedded into a recording, either in addition to or instead of the location information.

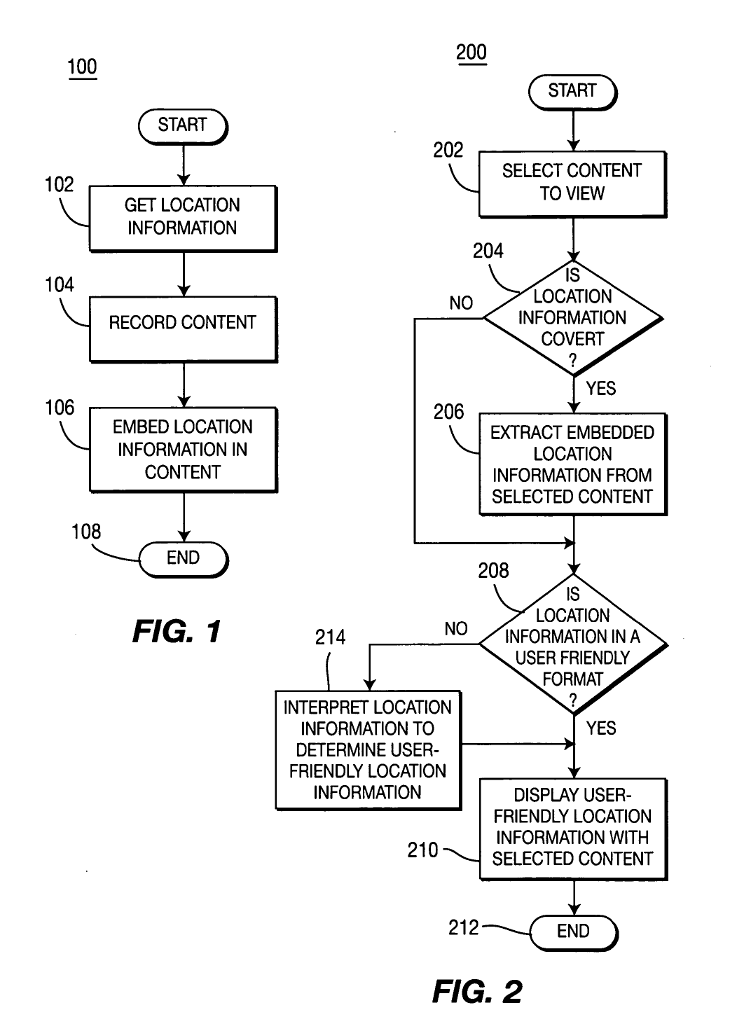

FIG. 1 is a flowchart of a method 100 for embedding location information in content created by a content creation device. When the content creation device accesses its multimedia device (e.g., a camera), location information relating to the present geographic location of the content creation device is obtained (step 102). It is noted that the location information may also be obtained by the content creation device on a periodic basis and the most recently obtained location information can be used in this step. The location information may be obtained by using available location information from a serving cell location, location services (LCS), GPS, voice recording, voice recognition, or other means.

The content is recorded at the content creation device (step 104). It is noted that steps 102 and 104 may be performed in the reverse order; such a reversal does not further alter operation of the invention. The location information is embedded into the content (step 106), and the method terminates (step 108). The location information may be embedded into the content object covertly, such as encoded into a watermark in a photograph, or embedded overtly, such as visible text in a photograph. In an alternate embodiment, the location information may be embedded in a user-friendly format (as opposed to raw location information such as latitude and longitude), such that it can easily be understood by a user.

The embedded information in the content object may be made overt, covert, or removed from content object file(s) prior to being exported from the device. For example, location information embedded into photographs on the device may be made part of the part of photograph file (e.g., the data is displayed when the file is viewed) before downloading to the local memory or being exported to another device such as a computer.

FIG. 2 is a flowchart of a method 200 for displaying location information in connection with a previously recorded content object. A user of the wireless device selects a content object to view (step 202). A determination is made whether the embedded location information is covert (step 204). If the embedded location information is covert, then the embedded location information is extracted from the selected content object (step 206). If the embedded location information is overt (step 204), then there is no need to extract it from the content object.

A determination is made whether the location information is in a user-friendly format (step 208). If the location information is already in a user-friendly format, then the selected content object is displayed with the user-friendly location information (step 210) and the method terminates (step 212).

If the location information is not already in a user-friendly format (step 208), then the location information is interpreted in order to permit display of user-friendly location information (step 214). One way of interpreting the location information includes using look-up tables to translate the raw location information into more user-friendly categories such as country, state, city, landmark, etc. The category level that can be supplied to the user depends on the available resolution of the location information. The look-up tables can be stored locally at the wireless device or downloaded from the network to the wireless device as needed. Alternatively, the location information can be interpreted by the network, and the user-friendly location information can be downloaded to the wireless device. The selected content object is displayed with the user-friendly location information (step 210) and the method terminates (step 212).

The embedded information may be made obvious when viewing the recorded content object (similar to the date and time information on some conventional photographs and video recordings) or the information may embedded in a non-obvious way, such as a watermark, only to be extracted as desired. Additional information may be embedded from other sources, such as a voice recording relating to the content object.

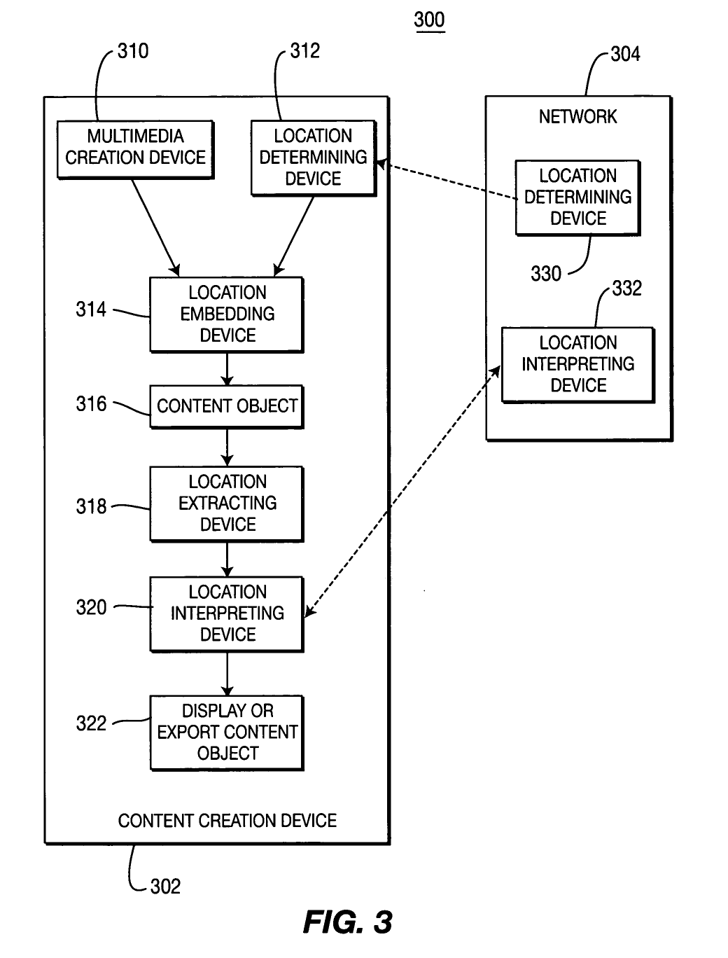

FIG. 3 is a diagram of a system 300 for embedding location information in a content object and extracting location information from a content object. The system 300 includes a content creation device 302 and a network 304. The content creation device 302 includes a multimedia creation device 310, a. location determining device 312, a location embedding device 314, the content object 316, a location extracting device 318, a location interpreting device 320, and a display 322. As noted above, the content creation device 302 can include a variety of devices, such as a wireless device with multimedia content creation capabilities. The network 304 includes a location determining device 330 and a location interpreting device 332.

In operation, the multimedia creation device 310 creates a content object and the location determining device 312 determines the current geographic location of the content creation device 302. If the content creation device 302 does not have capabilities to determine its own location, the content creation device can access the location determining device 330 on the network 304 to determine the current location of the content creation device 302. The location determining device 330 can assist the location determining device 312 or can be used as an alternative to the location determining device 312. The location embedding device 314 takes the content object from the multimedia creation device 310 and the location of the content creation device 302 from the location determining device 312 as inputs, and produces the content object 316 including the embedded location information.

When the user of the content creation device 302 desires to display a content object 316, the location extracting device 318 extracts the location information from the content object 316. The location interpreting device 320 interprets the extracted location information into user-friendly location information. In an alternate embodiment, if the location information was embedded overtly into the content object, then it would not need to be extracted. If the content creation device 302 is not capable of interpreting the location information, the location interpreting device 320 can request the location interpreting device 332 on the network 304 to interpret the location information into user-friendly location information. In an alternate embodiment, if the location information was embedded into the content object in a user-friendly format, the interpretation would not be necessary. The display 322 then displays the content object along with the user-friendly location information.

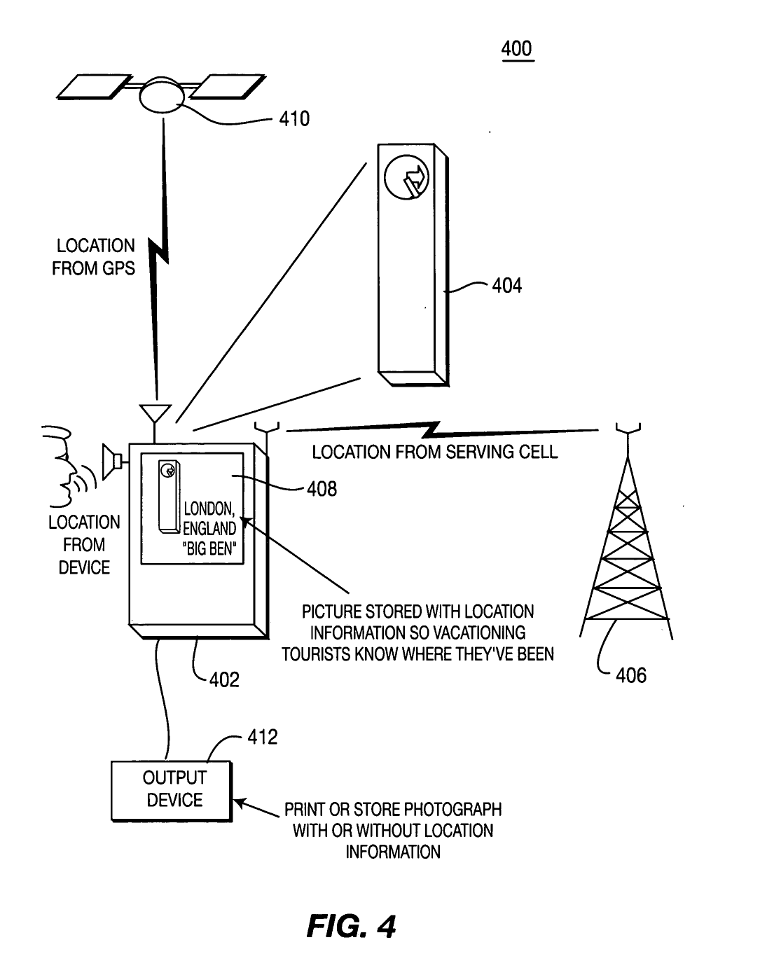

FIG. 4 is a diagram of a system 400 using the method 100. The system 400 includes a wireless device 402, an object to be recorded 404, and a network connection 406. The user of the wireless device 402 takes a photograph 408 of the object 404 (shown in this example as Big Ben). The wireless device 402 obtains the location information (this information may include raw data like longitude and latitude, a cell ID, or user-friendly data like: London, England, “Big Ben”) from the network 406 or from a GPS satellite 410, and embeds the location information into the photograph 408. The photograph 408 can be sent to an output device 412, such as a printer or computer, where the photograph 408 can be printed or stored either with or without the location information.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for embedding location information in a content object created on a content creation device, comprising the steps of:
obtaining location information relating to the current location of the content creation device;
creating the content object on the content creation device; and
embedding the location information into the content object.

2. The method according to claim 1, wherein the content creation device is a wireless device.

3. The method according to claim 2, wherein the obtaining step includes obtaining location information from a serving cell location.

4. The method according to claim 2, wherein the obtaining step includes obtaining location information from location services provided by a network used by the wireless device.

5. The method according to claim 1, wherein the obtaining step includes obtaining location information from a global positioning system.

6. The method according to claim 1, wherein the obtaining step includes obtaining location information from a voice recording of a user of the content creation device.

7. The method according to claim 1, wherein the obtaining step includes obtaining location information from voice recognition of a voice of a user of the content creation device.

8. The method according to claim 1, wherein the embedding step includes embedding the location information overtly, whereby the location information is readily apparent upon viewing the content object.

9. The method according to claim 1, wherein the embedding step includes embedding the location information covertly, whereby the location information is hidden upon viewing the content object.

10. A method for displaying location information in connection with a content object, comprising the steps of:
selecting a content object to view;
determining whether the location information for the selected content object is overt;
if the location information is overt, then displaying the selected content object with the location information;
if the location information is not overt, then:
extracting embedded location information from the selected content object;
interpreting the location information to determine user-friendly location information; and
displaying the user-friendly location information with the selected content object.

11. The method according to claim 10, wherein the interpreting step includes looking up location information in a table to obtain the user-friendly location information.

12. The method according to claim 11, wherein:
the method is performed on a wireless device;
the table is stored on the wireless device; and
the wireless device performs the interpreting step.

13. The method according to claim 11, wherein:
the method is performed on a wireless device;
the table is stored on a network used by the wireless device;
the table is downloaded from the network to the wireless device upon performing the interpreting step; and
the interpreting step is performed by the wireless device.

14. The method according to claim 11, wherein:
the method is performed on a wireless device;
the table is stored on a network used by the wireless device; and
the network performs the interpreting step and sends the user-friendly location information to the wireless device.

15. The method according to claim 10, wherein the user-friendly location information includes one or more items selected from the group consisting of: country, state, city, and landmark name.

16. A system for embedding location information in a content object, comprising:
a content creation device, configured to create a content object;
a first location determining device, configured to determine geographic location information of said content creation device; and
a location embedding device, configured to embed the location information into the content object.

17. The system according to claim 16, wherein said content creation device is a wireless device, the system further comprising:
a wireless network, through which said wireless device communicates, said wireless network including a second location determining device, configured to assist said first location determining device in determining geographic location information of said wireless device.

18. The system according to claim 17, wherein said second location determining device operates in place of said first location determining device.

19. A system for displaying user-friendly location information with a content object, comprising:
a location extracting device, configured to extract location information from a content object;
a first location interpreting device, configured to interpret the extracted location information into a user-friendly format; and
a display, configured to display the user-friendly location information along with the content object.

20. The system according to claim 19, wherein said location extracting device, said first location interpreting device, and said display are located in a wireless device, the system further comprising:
a wireless network, through which said wireless device communicates, said wireless network including a second location interpreting device, configured to assist said first location interpreting device in interpreting the extracted location information into a user-friendly format.

21. The system according to claim 19, wherein said second location interpreting device operates in place of said first location interpreting device.

22. A content creation device for embedding location information in a content object, comprising:
a multimedia creation device, configured to create a content object;
a location determining device, configured to determine a location of the content creation device; and
a location embedding device, configured to embed the location of the content creation device into the content object.

23. The content creation device according to claim 22, wherein said location determining device determines the location of the content creation device at the time the content object is created.

24. The content creation device according to claim 22, wherein said location determining device continually determines the location of the content creation device.

25. The content creation device according to claim 22, wherein said location determining device includes a global positioning system receiver.

26. The content creation device according to claim 22, wherein said location determining device includes a voice recording device whereby a user of the content creation device provides an audio comment.

27. The content creation device according to claim 22, wherein said location determining device includes a voice recognition device whereby a user of the content creation device provides an audio comment interpreted by said voice recognition device.

28. The content creation device according to claim 22, wherein the content creation device is a wireless device.
